(19) United States
(12) Patent Application Publication
(10) Pub. No.: US 2025/0056234 A1
(43) Pub. Date: Feb. 13, 2025

(54) PROCESS FOR COUPLING TWO DEVICES OF PERSONAL PROTECTIVE EQUIPMENT FOR WIRELESS COMMUNICATION, SYSTEM FOR PERSONAL PROTECTIVE EQUIPMENT AND PROTECTIVE EQUIPMENT

(71) Applicant: Dräger Safety AG & Co. KGaA, Lübeck (DE)

(72) Inventors: Achim VOLMER, Lübeck (DE); Michael BRODERSEN, Lübeck (DE); Lukas OSTERMANN, Lübeck (DE); Marco GIMM, Lübeck (DE)

(21) Appl. No.: 18/795,309

(22) Filed: Aug. 6, 2024

(30) Foreign Application Priority Data
Aug. 7, 2023 (DE) 10 2023 120 929.9

(51) Int. Cl. H04W 12/55; A62B 7/02; H04B 17/318; H04W 4/80

(52) U.S. Cl. CPC H04W 12/55; A62B 7/02; H04B 17/318; H04W 4/80

(57) ABSTRACT

A process couples personal protective equipment devices configured to communicate wirelessly with each other. A first registration signal (S1) is transmitted from a first transmitter (6a) of a first device (1). The first registration signal is received with a first and second receivers (4a, 4b) of a second device (2) and is attenuated on a first path (9a) to the first receiver differently than on a second path (9b) to the second receiver. A first path signal strength and a second path signal strength of the first registration signal are measured. A difference value (41) of the first path signal strength and the second path signal strength is measured. The first device and the second device are coupled taking into account the difference value. A system for personal protective equipment and personal protective equipment, including a compressed air breathing apparatus (62), are configured to carrying out the process.

### CROSS REFERENCE TO RELATED APPLICATIONS

This application claims the benefit of priority under 35 U.S.C. § 119 of German Application 10 2023 120 929.9, filed Aug. 7, 2023, the entire contents of which are incorporated herein by reference.

### TECHNICAL FIELD

The present invention relates to a process for coupling (pairing) two devices of personal protective equipment which are configured to communicate wirelessly with each other. The invention also relates to a system for personal protective equipment and protective equipment with a compressed air breathing apparatus, which are suitable for carrying out such a process.

### BACKGROUND

Personal protective equipment refers to special equipment for the self-protection of a person who performs activities that are potentially hazardous to health. This includes, among other things, clothing, objects and equipment that are usually prescribed when carrying out such activities. Due to the regulations and, above all, to avoid the risk of damage to health, personal protective equipment is used frequently and in various areas. The requirements for personal protective equipment in terms of reliability and ease of use are therefore very important. The latter is particularly important for the comfort of the user and to avoid misuse. Furthermore, the areas of application often involve demanding environmental conditions, such as extreme temperatures, which require particularly robust equipment.

As in other areas, more and more electronic and digital devices are now being used as part of personal protective equipment. These include, for example, display, measurement and evaluation units as well as data transmission units. Often, several such devices are part of an individual person's protective equipment and are networked with each other, for example to exchange data. This further development can significantly improve the comfort and safety of personal protective equipment. For example, compressed air breathing apparatus with a digital display on the upper body showing the fill level of the breathing gas cylinder is used in the field of respiratory protection. In a special technical solution, this fill level is transmitted to and displayed on a display unit in the user's field of vision, for example inside a respirator mask. This has the advantage that the user always has the important fill level of the breathing gas cylinder in their field of vision during their activity and does not have to interrupt it to check the fill level.

The type of networking, in particular the coupling of two such devices of personal protective equipment, is of particular importance and has an influence on reliability and ease of use. Coupling, also known as pairing, of two communicating devices refers to the initial establishment of a connection between two devices to authorize further data exchange. This involves exchanging identification data of the devices so that paired devices can then easily identify each other and directly establish a connection for data exchange. Ideally, only those devices that belong together in relation to the application should be linked. In the aforementioned example, this means the compressed air breathing apparatus with the level indicator integrated in the respirator mask, whereby the compressed air breathing apparatus and the respirator mask are worn by the same person. Determining which devices belong together and should be coupled with each other, namely the devices worn by the same person, poses a particular challenge, as in such application scenarios there are usually several people with the same protective equipment in the immediate or at least indirect vicinity.

When using wireless communication systems, a direct connection between two devices usually has to be configured and established first, as there are usually more than just two devices in the radio range. Such coupling can be done manually, with the two devices intended for communication being defined by the user. This is time-consuming and often requires technical knowledge that is not necessary for the intended use of the devices of personal protective equipment. In addition, manually initiated coupling can lead to errors, so that it is carried out incorrectly or unknowingly between the wrong devices. In the worst case, such an error remains undetected so that, for example, the fill level of a breathing gas cylinder worn by a first person is transferred to a fill level indicator in a respirator mask worn by a second person and vice versa. Such a case must be avoided for the safety of the people involved.

One known way of automatically coupling two devices is to evaluate the signal strength of a transmitted signal. This makes use of the fact that the signal strength of a received signal in free space decreases proportionally to the inverse of the distance of a transmitter of the signal. This means, for example, that the devices with the greatest signal strength can be coupled together.

Coupling two devices of personal protective equipment by evaluating signal strengths has the problem that the human body attenuates the transmitted signals under certain circumstances and therefore it cannot be ensured that the signal strength and the distance between the devices are proportional to each other, which makes it at least difficult to determine whether the devices belong together. Furthermore, reflections occur during the transmission of the signals, whereby the respective signal strength is influenced. The attenuation of signals by the human body and their reflections are particularly relevant in relation to standard radio technologies. These are in a frequency range of a few gigahertz, for example 2.4 gigahertz, and have a short wavelength, whereby a registration signal is absorbed and attenuated by the human body due to a significantly higher dielectric constant compared to air. Furthermore, the ranges of such standard radio technologies are so long that there is increased reflection of the transmitted signals, which also results in an attenuation of the signal strength. It is therefore not easy to draw conclusions about the distance between devices, and therefore about whether two devices of personal protective equipment belong together, based on the signal strength of a signal transmitted from a transmitter to a receiver.

### SUMMARY

Based on the solutions known from the prior art and the problems described above, the invention is based on the object of providing a process for coupling two devices communicating wirelessly with one another, by means of which coupling is made possible in a simple and reliable manner. In the presence of several wirelessly communicating devices which can be coupled to one another, those two devices which belong together in relation to the application are to be coupled to one another automatically and reliably. In the case of personal protective equipment, this means those devices that are worn by the same person or that are intended to communicate with each other and exchange data according to the application. A system for personal protective equipment and personal protective equipment with a compressed air breathing apparatus suitable for carrying out this process should also be specified.

The foregoing problem is solved by a process with features according to the invention, a system for personal protective equipment with features according to the invention and personal protective equipment, with a compressed air breathing apparatus, with features according to the invention. Further details of the invention can be appreciated from this disclosure including the description, the drawings and the claims. Features and details which are described in connection with the process according to the invention naturally also apply in connection with the system for personal protective equipment according to the invention and the personal protective equipment with a compressed air breathing apparatus according to the invention, so that reference is always made or rather can be made reciprocally with regard to the disclosure to the individual aspects of the invention.

The process according to the invention for coupling a first device and a second device of a personal protective equipment, which are configured to communicate wirelessly with each other, comprises the following steps:
transmitting a first registration signal (logon signal/login signal/pairing signal) from a first transmitter of the first device,
receiving the first registration signal with a first receiver and with a second receiver of the second device, wherein the first registration signal experiences a different attenuation on a first path to the first receiver than on a second path to the second receiver,
measuring a first signal strength (a first path signal strength) of the first registration signal transmitted via the first link and a second signal strength (a second path signal strength) of the first registration signal transmitted via the second link,
determining a first difference value of the first signal strength and the second signal strength, and
coupling of the first device and the second device (or not), taking into account (based on) the first difference value.

The coupling, also known as pairing, of two devices that are configured to communicate wirelessly with each other is understood as a communication-related linking of these devices. It is usually the prerequisite for further communication and for further data exchange between the two devices. In the case of coupled devices, at least one device aware of information for uniquely identifying the other device and direct communication from one device to the other is therefore possible.

A registration signal, also known as an advertisement in special embodiments, is a wirelessly transmitted signal from a transmitter that contains at least one piece of information to uniquely identify the transmitter and is not directed to a specific receiver and/or communication partner. This means that the registration signal can be received by receivers that are set up accordingly and are within range of the transmitter. Typically, the registration signal does not contain any specific information relating to the application, such as the fill level of a breathing gas cylinder, and is only used to establish initial contact between the transmitter and the receivers that are within range of the transmitter. The receivers and/or evaluation units connected to them for data exchange can then, for example, evaluate the received registration signal and carry out further actions related to the communication between the transmitter and receiver.

A process according to the invention for coupling two devices which are configured to communicate wirelessly with each other is initiated by the transmission of the first registration signal of the first transmitter of the first device. The first registration signal contains at least one piece of information for identifying the first transmitter. This can include, for example, a MAC (Media Access Control) address, a hardware address, a device address, a serial number or other identification information. This identification information makes it possible to clearly distinguish the first transmitter and/or the first device with the first transmitter from other transmitters and devices. Further information contained in the first registration signal may include properties, for example version information or status information, for example a charge status, of the first transmitter and/or the first device.

The first registration signal is received by the first and second receivers of the second device. It is conceivable that the process is implemented with more than two receivers, which will be explained in more detail below. The receivers are arranged in such a way that different paths with different attenuation characteristics result during the transmission of the first registration signal from the first transmitter to the first and second receiver when the process is implemented.

The first and second signal strengths of the first registration signal are preferably determined by the first and second receivers, whereby the signal strengths differ due to the different attenuation on the first and second paths. With two receivers, the first signal strength and the second signal strength are obtained, whereby the first signal strength is, for example, lower than the second signal strength or the second signal strength is lower than the first signal strength. Which value is greater depends on the aforementioned arrangement of the first and second receivers in relation to the first transmitter and the associated attenuation of the first registration signal on the first and second paths.

The first difference value is determined from the different signal strengths of the first registration signal due to the different attenuations on the respective paths. If there are two receivers, the value of the first signal strength is subtracted from the value of the second signal strength or vice versa. If the second device has more than two receivers, the first difference value is determined accordingly from all measured signal strengths and all other values are subtracted from the value of the first signal strength, for example, according to the number of receivers

The automatic coupling of the first and second devices is preferably carried out taking into account the amount of the determined difference value. The aim of the technical solution is to couple together those two devices that belong together according to the application. According to a particular embodiment, this means the devices that are worn by the same person and have a correspondingly small distance between them. According to the invention, the smallest distance between two corresponding devices, in particular a first and a second device, leads to the largest determined difference value, since the signal strength of the respective registration signal decreases as the distance between two corresponding devices increases. The devices for which the largest difference value was determined are therefore automatically coupled with each other. In the case of the first and second devices and the first registration signal, the first difference value is the largest difference value. As a result, the first and second devices are coupled together. Alternatively, or additionally, it is conceivable that the automatic coupling is only carried out if the first difference value exceeds a predefined threshold, for example 10 dB, or lies within a certain value range. The threshold and/or value range are selected in such a way that as soon as the first difference value is below the threshold or outside the value range, it can be ruled out that the first and second device are worn by the same person and accordingly no automatic coupling is performed. If the first difference value is above this threshold or within the value range, the automatic coupling of the first and second devices is carried out.

The process according to the invention for coupling two devices of personal protective equipment, which are configured to communicate wirelessly with each other, has the particular advantage over the known processes that there are hardly any restrictions in the choice of radio technology and established radio standards, such as Bluetooth, Wi-Fi, Zigbee or other WPANs (Wireless Personal Area Network) can be used. This is made possible by determining at least one difference value of the signal strengths of the registration signals received by two or more receivers and the arrangement of at least two receivers relative to the transmitter in accordance with the invention. The arrangement of the receivers produces a characteristic difference value on the basis of which a coupling of two associated devices can be reliably performed. Furthermore, different signal powers of the transmitter have hardly any influence, since a difference value of signal strengths is advantageously taken into account in the coupling and not the signal strength itself, which fluctuates with different signal powers. The process is therefore very robust and the characteristic difference value remains the same even if the signal power of the transmitter(s) varies.

A further advantage is that the coupling can be established automatically, reliably and cost-effectively using simple means, with no manual interaction by the user required. Furthermore, time is saved and errors relating to the coupling of two devices are avoided. This means that the technical solution can be seamlessly integrated into the user's practical workflow. No technical knowledge relating to the coupling of the two devices is required and the user does not need any special technical instruction in the process of coupling two devices. Due to the wireless communication and the coupling carried out according to the invention, there are no special mechanical requirements for the personal protective equipment, such as a respiratory mask, since the devices between which a wireless communication link can be established can be added to components of personal protective equipment without great effort.

According to a preferred further development, the process additionally comprises the following steps:
receiving a second registration signal (a third device registration signal) transmitted over a third link from a second transmitter of a third device (a third device transmitter) with the first receiver and receiving the second registration signal transmitted over a fourth link with the second receiver, the second registration signal being attenuated differently on the third link than on the fourth link,
measuring a third signal strength (a third path signal strength) of the second registration signal transmitted via the third link and a fourth signal strength (a fourth path signal strength) of the second registration signal transmitted via the fourth link,
determining a second difference value of the third and fourth signal strength, and
coupling of the first and the second device or the second and the third device, taking into account a comparison of the first difference value and the second difference value.

In the event that more than one device with a transmitter emitting a registration signal is located in the reception range of the second device with its first and second receivers, the second registration signal is also received by the first and second receivers. The second registration signal differs from the first registration signal at least in the unique identification, for example the MAC address, of the second transmitter of the third device. This makes it possible to differentiate between the various devices, each of which is equipped with a transmitter that emits a registration signal. The registration signals can therefore be assigned to the respective transmitters.

According to this embodiment, the third and fourth paths are used for the transmission of the second registration signal, which experiences a different attenuation on each of the paths until it is received by the first and second receivers. This results in the third signal strength, which is preferably measured by a measuring unit connected to the first receiver, and the fourth signal strength, which is preferably measured by a measuring unit connected to the second receiver. Due to the different attenuation of the second registration signal on the third and fourth path, different signal strengths also result, from which the second difference value is determined. Automatic coupling then takes place between the devices for which the largest amount of the difference value was determined.

This leads to a correct coupling of two related devices, as the attenuations of the first registration signal on the first and second path and the attenuations of the second registration signal on the third and fourth path differ from each other. For example, if the amount of the first difference value is greater than the amount of the second difference value, the second and first devices are coupled together. If the amount of the second difference value is greater than the amount of the first difference value, the second device and the third device are coupled together.

As already indicated, it is conceivable that there are more than two devices with a transmitter in the reception range of the receiver of the second device, which can be coupled to the second device. Depending on the number of transmitters, the number of difference values results accordingly. According to the invention, the second device is automatically coupled to the device to which the largest amount of the determined difference value results, as described above. In an advantageous manner, the automatic coupling of two devices of a personal protective equipment takes place between the two devices which are the closest to each other and accordingly belong to the protective equipment of the same person. In an environment with several devices, each of which has a transmitter, the device that has a transmitter is automatically coupled to the second device that belongs to it.

According to a preferred further development of the process, some or all of the process steps are repeated.

In the event that only a single transmitter, for example only the first transmitter of the first device, is located in the reception range of the first and second receivers, the process steps:
transmitting a first registration signal from a first transmitter of the first device,
receiving the first registration signal with a first receiver and with a second receiver of the second device, wherein the first registration signal experiences a different attenuation on a first path to the first receiver than on a second path to the second receiver,
measuring a first signal strength of the first registration signal transmitted via the first link and a second signal strength of the first registration signal transmitted via the second link, and
determining a first difference value of the first signal strength and the second signal strength, are repeated as described above. Accordingly, the first transmitter of the first device again transmits a first registration signal, which is received by the first and second receivers of the second device.

The signal strengths are then measured and a further first difference value is determined therefrom, which is taken into account in the coupling. It is conceivable here that only this further first difference value, which is associated with the first device, is taken into account in the coupling or preferably in combination with the previously determined first difference value or values, for example in the form of an average value, an index calculation (key figure calculation) or similar. Particularly preferably, the transmission of the first registration signal is repeated several times, for example at a repetition rate of 100 ms, as will be described in more detail below.

In the event that two or more transmitters are located in the reception range of the receivers, for example the first and the second transmitter, as also described above, the process steps:
receiving a second registration signal transmitted over a third link from a second transmitter of a third device with the first receiver and receiving the second registration signal transmitted over a fourth link with the second receiver, the second registration signal being attenuated differently on the third link than on the fourth link,
measuring a third signal strength of the second registration signal transmitted via the third link and a fourth signal strength of the second registration signal transmitted via the fourth link, and
determining a second difference value of the third and fourth signal strength,
   are also repeated. In this case, the first transmitter of the first device again transmits a first registration signal, which is received by the first and second receivers of the second device. The signal strengths are measured and a further difference value is determined therefrom. The second transmitter of the third device again transmits a second registration signal, which is received by the receivers of the second device. The signal strengths are measured and another second difference value is determined from this. The coupling now takes into account a comparison of this difference value, which is associated with the third device, with the further first difference value, which is associated with the first device. It is conceivable that only these two further difference values are taken into account in the coupling, or preferably in combination with the previously determined first and second difference values. In this case, the difference values associated with the respective device are summarized, for example in the form of an average value, an index calculation or similar, and taken into account in the coupling. Particularly preferably, the transmission of the first and second registration signals is repeated several times, for example at a repetition rate of 100 ms, as will be described in more detail below.

The particular advantage of repetition is that the coupling of two devices can be adapted to changing conditions. This is relevant, for example, if the position of the first device relative to the second device changes and it is determined, for example, that the devices no longer belong together, or the third and second devices are coupled to one another, but the conditions change such that the first and second devices now belong together. In these cases, by repeating the process steps, those devices which belong together according to the current situation are coupled together. For example, this occurs in the case of personal protective equipment with a respirator mask and a compressed air breathing apparatus when the respirator mask or the compressed air breathing apparatus of a person is replaced. In this case, the automatic coupling of the associated devices takes place reliably even under changing conditions.

The repetition of the process steps preferably takes place at time intervals and ends with a successful coupling or is particularly preferably continued and only ends when the devices carrying out the process are switched off.

In a further preferred embodiment of the process, the sign of the first difference value and/or the second difference value, if the second difference value has been determined and there is more than one individual transmitter, is taken into account in the coupling.

The difference value is determined after the minuend and the subtrahend have been defined depending on the arrangement of the first and second receivers in relation to the transmitter. The measured signal strength of the receiver that has the smallest distance according to the intended arrangement of the receivers forms the minuend, for example the first signal strength. The signal strength of the receiver with the greatest distance to the transmitter according to the intended arrangement forms the subtrahend, for example the second signal strength. When the first and second devices are used as intended, this results in a difference value that is greater than zero. If the difference value is negative, this is not an intended arrangement and the two corresponding devices are not recognized as belonging together and are not coupled with each other. The difference value is negative, for example, if the first device is arranged relative to the second device and its receiver in such a way that the first signal strength of the first receiver is less than the second signal strength of the second receiver. Consequently, the process determines in a simple and reliable manner, taking into account the sign of the difference value, whether two devices of a personal protective equipment belong together and whether an automatic coupling of these devices should be carried out or not.

According to a preferred further development of the process, the transmission of the first registration signal and/or the second registration signal, if a second transmitter is within range of the receivers of the second device, and the determination of the first difference value and/or the second difference value, if a second registration signal has been received, is repeated before the coupling.

With a preferred repetition rate of the transmission of the first and/or second registration signal of one second, the process according to the invention is even more reliable, since several first and/or second difference values can be determined and are taken into account in the coupling. Preferably, a first difference value is determined for several, for example ten, registration signals of a first device. An average value is then formed from, for example, ten first difference values and taken into account in the coupling. The advantage is that the influence of any measurement inaccuracies of the signal strengths and/or interference during the transmission of the respective registration signal is reduced.

In a further preferred embodiment of the process, a first characteristic value is determined during the coupling on the basis of at least two first difference values and/or a second characteristic value is determined on the basis of at least two second difference values, provided that at least two first and/or at least two second registration signals have been received from which the at least two first and/or at least two second difference values can be determined. As described above, the plurality of first and/or second difference values are determined from a plurality of registration signals of the respective transmitter transmitted at a time interval.

Such a characteristic value is determined for those devices that have a transmitter. First, the value of the respective characteristic value is equated with the difference value determined first in terms of time. The characteristic value is then compared with the subsequent difference value in relation to the same device. If the characteristic value is smaller than the difference value, the characteristic value is incremented by a predefined value, for example 0.1 dB. If the characteristic value is greater than the difference value, the characteristic value is decremented by a predefined value, for example 0.1 dB. If the difference value and the characteristic value are essentially the same, for example less than 1% difference, the characteristic value is not changed. Preferably, the characteristic value is updated once per second, with further registration signals being sent every second and further difference values being determined every second. During coupling, the devices whose characteristic value has the highest value are coupled together. In an advantageous way, the process is therefore even more reliable, especially with transmitters located close to each other, and more stable in the face of fluctuating signal strengths.

According to a preferred further development of the process, the first device and the third device, if the third device is present, can be attached at least indirectly to the head of a person and the second device can be attached at least indirectly to the torso of a person. Furthermore, the second device is preferably configured such that the torso of a person is located between the first receiver and the second receiver, provided that the second device is at least indirectly attached to a person. Furthermore, the first transmitter is preferably arranged on a first display unit for a respiratory mask and/or the second transmitter, if present, is arranged on a second display unit for a respiratory mask and the first receiver and the second receiver are arranged on a compressed air breathing apparatus.

The arrangement of the transmitter on the head of a person to the receivers in the area of the torso of the same person in accordance with the invention results in characteristic differences with regard to the attenuations on the various paths for transmitting the registration signals and thus in the measured signal strengths of the registration signals. These characteristic differences in the signal strengths can be advantageously used for coupling two devices together. A particular advantage of this arrangement is the essentially constant distances between the transmitter arranged on the head and the receivers arranged on the torso. Even if the person moves, the distances remain virtually the same due to the small movement radii of the head and torso. Furthermore, due to the arrangement of the receivers on the opposite side of the torso, at least one section of the registration signal runs through the torso, which causes a specific attenuation of the signal strength that is determined at the corresponding receiver. This specific attenuation also contributes to the characteristic difference in the measured signal strengths, so that the correct coupling of two associated devices is particularly reliable, taking into account the difference values of the signal strengths.

In a particular preferred embodiment of the process, the signal strength is measured based on an RSSI (Received Signal Strength Indication) value of the at least one first registration signal and/or the at least one second registration signal if a second transmitter is within range of the first and second receiver.

The RSSI value is an indicator for the received field strength of wireless communication applications and can be used to determine the signal strength of the respective registration signal in an advantageous way due to the availability of a large number of radio technologies.

In another preferred embodiment of the process, the wireless communication is based on Bluetooth wireless technology.

Bluetooth is widely used as a radio technology and is used in various areas of application, including in the field of personal protective equipment. The process according to the invention enables the automatic coupling of two associated devices of a personal protective equipment with Bluetooth as radio technology by taking into account the deficits of this radio technology, in particular the influence on the signal strength due, for example, to reflections of the signals in the environment and attenuation by the body of a person, and at least partially eliminating them by using several receivers.

The invention further relates to a system for personal protective equipment comprising a second device (a device), wherein the second device comprises the following:
a first receiver and a second receiver for receiving a first registration signal, the first receiver having a first measuring unit and the second receiver having a second measuring unit for measuring a signal strength of the first registration signal,
an evaluation unit for determining a first difference value of the measured signal strengths and for evaluating the determined first difference value, and
a second coupling unit for wireless coupling with a coupling unit of another device, in particular with a device having a transmitter emitting the first registration signal.

The proposed system for personal protective equipment with a second device is suitable for carrying out the process according to the invention. It is conceivable that the device has further receivers in addition to the first and second receivers. This makes it possible in an advantageous way to adapt the process flexibly to external conditions, for example environmental conditions and/or to the protective equipment, and to increase reliability. It is essential that the first registration signal reaches the respective receivers via different paths and is attenuated differently in each case. This results in different measured signal strengths and a characteristic difference value depending on the number of receivers. According to the invention, the characteristic difference value is generated by the geometric arrangement of the receivers. These are arranged in such a way that, during intended use, an attenuating element is located on at least one section of the path of the first registration signal to one of the receivers. This can be, for example, a part of the body of a person wearing the personal protective equipment. Preferably, the receivers are of the same type, i.e. of the same design and range of functions. The receivers have a receiver unit that is able to receive the first registration signal. It is also conceivable that at least one of the receivers is configured as a transceiver and also comprises a transmitter unit in addition to a receiver unit. This has the advantage that, in addition to receiving, the receiver as a communication component is also suitable for transmitting data and can be used for further communication and coupling with another device.

The signal strength is measured using a measuring unit, which is preferably integrated into the receiver unit of the respective receiver. A separate measuring unit, i.e. separate from the receiver unit, is also conceivable.

The evaluation unit is, for example, a microprocessor that is connected to the receivers and the coupling unit and configured for data exchange.

The evaluation unit and the coupling unit are particularly preferably components of at least one receiver. This reduces the number of components and the number of connections for data transmission between the components. Such a receiver can, for example, comprise a Bluetooth module with receiver unit, measuring unit, evaluation unit and coupling unit.

In a preferred further development, the system comprises, in addition to the second device, a first device with a first transmitter for transmitting the first registration signal and a first coupling unit for wireless coupling with the second coupling unit.

The first transmitter is suitable for wireless communication with the receivers of the second device and comprises at least one transmitter unit which is capable of transmitting a first registration signal. It is also conceivable that the first transmitter is configured as a transceiver and, in addition to a transmitter unit, also comprises a receiver unit. This has the advantage that the first transmitter, as a communication component, is also configured to receive signals in addition to transmitting them and is configured for further communication and coupling with another device. The first coupling unit is preferably also part of the first transmitter.

The invention also relates to personal protective equipment with a compressed air breathing apparatus on which a second device (a device) is arranged, the second device comprising the following:
a first receiver and a second receiver for receiving a first registration signal, the first receiver having a first measuring unit and the second receiver having a second measuring unit for measuring a signal strength of the first registration signal,
an evaluation unit for determining a first difference value of the measured signal strengths and for evaluating the determined first difference value, and
a second coupling unit for wireless coupling with a coupling unit of another device, in particular with a device having a transmitter emitting the registration signal.

The proposed personal protective equipment with a compressed air breathing apparatus on which a second device is arranged is suitable for carrying out the process according to the invention. A compressed air breathing apparatus has, for example, a breathing gas cylinder, a shoulder and lap belt, a carrying plate and a monitoring unit with a pressure gauge. The second device is preferably arranged on the compressed air breathing apparatus in such a way that the first receiver is integrated in the monitoring unit in the chest area and the second receiver is integrated in the carrying plate in the lower back area of a person. It is conceivable that the second device has further receivers in addition to the first and second receivers. This makes it advantageously possible to adapt the process flexibly to external conditions, for example environmental conditions and/or to the protective equipment, and to increase reliability. It is essential that the first registration signal reaches the respective receivers via different paths and is attenuated differently in each case. This results in different measured signal strengths and a characteristic difference value depending on the number of receivers. According to the invention, the characteristic difference value is achieved by the geometric arrangement of the receivers. These are arranged in such a way that, during intended use, an attenuating element is located on at least one section of the path of the first registration signal to one of the receivers. This can be, for example, a part of the body of a person wearing the personal protective equipment. Preferably, the receivers are of the same type, i.e. of the same configuration and range of functions. The receivers have a receiver unit that is able to receive the registration signal. It is also conceivable that at least one of the receivers is configured as a transceiver and also comprises a transmitter unit in addition to a receiver unit. This has the advantage that the receiver, as a communication component, is also suitable for transmitting data in addition to receiving and can be used for further communication and coupling with another device.

The signal strength is measured using a measuring unit, which is preferably integrated into the receiver unit of the respective receiver. A separate measuring unit, i.e. separate from the receiver unit, is also conceivable.

The evaluation unit is, for example, a microprocessor that is connected to the receivers and the coupling unit and configured for data exchange.

The evaluation unit and the coupling unit are particularly preferably components of at least one receiver. This reduces the number of components and the number of connections for data transmission between the components. Such a receiver can, for example, comprise a Bluetooth module.

In a preferred further development, the personal protective equipment has a display unit for a respirator mask, with a first device being arranged on the display unit. The display unit can be arranged in or on the respirator mask and the first device is attached to the display unit or integrated in the display unit. The first device comprises a first transmitter for transmitting the first registration signal and a first coupling unit for wireless coupling with the second coupling unit.

The first transmitter is suitable for wireless communication with the receivers of the second device and comprises at least one transmitter unit which is capable of transmitting a first registration signal. It is also conceivable that the first transmitter is configured as a transceiver and, in addition to a transmitter unit, also comprises a receiver unit. This has the advantage that the first transmitter, as a communication component, is also configured to receive signals in addition to transmitting them and is configured for further communication and coupling with another device. The coupling unit is preferably also part of the first transmitter.

Further features, functions and effects of the invention are shown in the description and the accompanying figures. Examples of embodiments of the invention are described without limiting the general idea of the invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic representation of a first, second and third device;

FIG. 2 is a flow chart of one embodiment of the process according to the invention;

FIG. 3 is a sequence diagram of an embodiment of the process according to the invention;

FIG. 4 is a schematic relationship between RSSI and distance transmitter to receiver,

FIG. 5 is a schematic representation of a compressed air breathing apparatus and two display units.

### DESCRIPTION OF PREFERRED EMBODIMENTS

In the following, embodiments of the invention are described in detail with reference to the attached figures. The same components in several figures are each provided with the same reference characters. The principle on which the invention is based is first described.

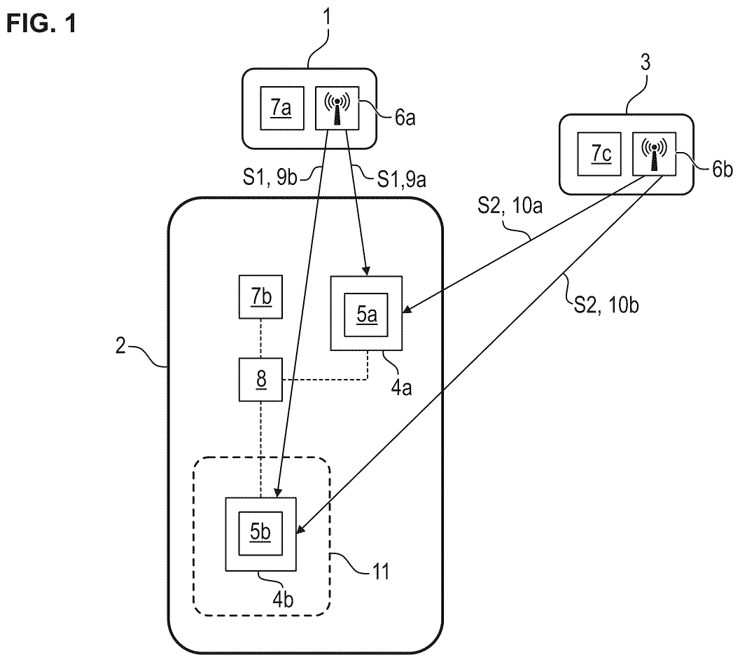

FIG. 1 shows a preferred embodiment of personal protective equipment with a first device 1, which may be a respirator mask, a second device 2, for example in the form of a compressed air breather, and a third device 3, which may be a further respirator mask, wherein the first device 1 and the second device 2 are associated with the personal protective equipment of one person and the third device 3 is associated with the protective equipment of another person. The three devices 1, 2, 3 are able to communicate with each other wirelessly. The second device 2 comprises a first receiver (first receiver of the second device) 4a and a second receiver (second receiver of the second device) 4b for receiving a registration signal. Furthermore, the first receiver 4a comprises a first measuring unit 5a and the second receiver 4b comprises a second measuring unit 5b, which are configured to measure a signal strength, for example in the form of an RSSI (Received Signal Strength Indicator), of a wirelessly transmitted registration signal. Furthermore, the second device 2 comprises a second coupling unit 7b for coupling the second and the first device 2, 1 or the second and the third device 2, 3. The second device 2 further comprises an evaluation unit 8 which exchanges data and/or control signals with the first and the second receiver 4a, 4b and with the second coupling unit 7b, as indicated by the dotted lines. The first device 1 comprises a first transmitter (a first device transmitter) 6a for transmitting a first registration signal (a first device registration signal) S1 and the third device 3 comprises a second transmitter (a third device transmitter) 6b for transmitting a second registration signal (a third device registration signal) S2. Furthermore, the first device 1 comprises a first coupling unit 7a and the third device 3 comprises a third coupling unit 7c for coupling with the second device 2.

After the personal protective equipment has been put into operation, the first transmitter 6a of the first device 1 transmits a first registration signal S1 and the second transmitter 6b of the third device 3 transmits a second registration signal S2. The first registration signal S1 of the first transmitter 6a is transmitted via the first path 9a to the first receiver 4a and via the second path 9b to the second receiver 4b. The first path 9a is shorter than the second path 9b and the first registration signal S1 is attenuated on the second path 9b by a radio signal attenuating element 11, which is arranged between the first transmitter 6a and the second receiver 4b. The radio signal attenuating element 11 can be a part of a person's body. The second registration signal S2 of the second transmitter 6b is transmitted via the third path 10a to the first receiver 4a and via the fourth path 10b to the second receiver 4b, wherein the third path 10a is shorter than the fourth path 10b and the second registration signal S2 on the fourth path 10b is also attenuated by the radio signal attenuating element 11, which is arranged between the second transmitter 6b and the second receiver 4b.

The arrangement of the receivers according to the invention and the resulting characteristic difference values of the measured signal strengths of the registration signals reliably determine which devices belong together and perform automatic coupling. The devices for which the larger difference value was determined are coupled together.

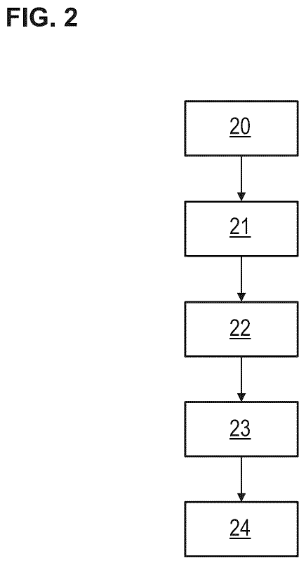

FIG. 2 schematically shows a flow chart of a preferred embodiment of the process according to the invention. In a first process step 20, the first transmitter 6a of the first device 1 transmits a first registration signal S1. In this embodiment, the radio technology for transmitting the first registration signal S1 is Bluetooth.

The first registration signal S1 is received in a second process step 21 by the first and second receivers 4a, 4b of the second device 2, wherein the first registration signal S1 is attenuated differently on the first and second paths 10a, 10b to the first and second receivers 4a, 4b. The different attenuation is achieved by the radio signal attenuating element 11 and/or by different lengths of the paths 10a, 10b.

In a third process step 22, a first signal strength is measured by the first measuring unit 5a of the first receiver 4a and a second signal strength is measured by a second measuring unit 5b of the second receiver 4b. In the embodiment example according to FIG. 2, the RSSI values are measured.

Using the first and second signal strength, a first difference value is determined in a fourth process step 23, wherein the value of the measured signal strength of the second measuring unit 5b is subtracted from the value of the measured signal strength of the first measuring unit 5a, since the first receiver 4a, in an intended use, is closer to a transmitter of the associated device and thus the signal strength is greater than that of the second receiver 4b due to the lower attenuation.

In a fifth process step 24, the determined first difference value is compared with other difference values of other devices which are equipped with a transmitter and are located in the reception range of the receivers of the second device 2. If it is determined that the first difference value is the largest value of the determined difference values, the first device 1 and the second device 2 are coupled to one another via the first and second coupling units 7a, 7b. It has been established that the first device 1 and the second device 2 belong together and the coupling creates the prerequisite for them to be able to exchange further data with each other.

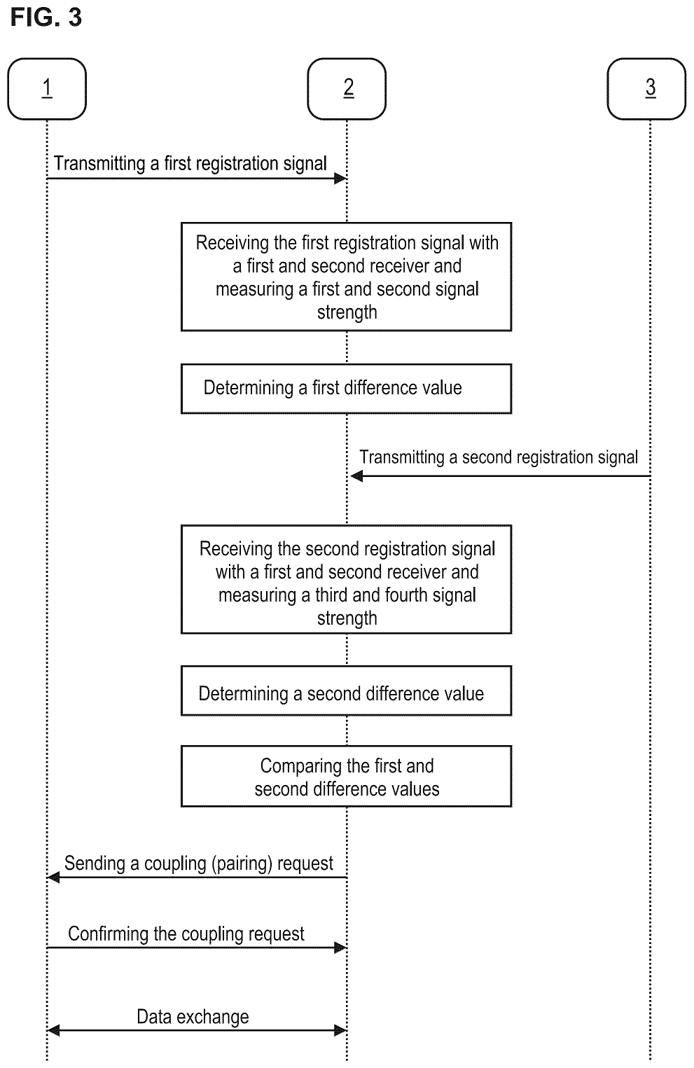

In FIG. 3, a further preferred embodiment of the process according to the invention is shown schematically in a sequence diagram. In this sequence diagram, an exemplary communication between the first device 1 and the second device 2 as well as the third device 3 and the second device 2 is illustrated. First, the first transmitter 6a transmits a first registration signal S1, which is received by the first receiver 4a and the second receiver 4b. The first and second measuring units 5a, 5b measure a first and a second signal strength and the evaluation unit 8 determines a first difference value from these signal strengths. The second transmitter 6b then transmits a second registration signal S2, which is received by the first and second receivers 4a, 4b. The first and second measuring units 5a, 5b measure a third and a fourth signal strength and the evaluation unit 8 determines a second difference value from these signal strengths. The evaluation unit 8 then compares the first and second difference values, whereby the first difference value is greater than the second difference value. Accordingly, the evaluation unit 8 controls the second coupling unit 7b so that it sends a coupling request to the first coupling unit 7a. This request, addressed directly to the first coupling unit 7a, is made possible by the information for identifying the first transmitter 6a in the first registration signal S1. The first coupling unit 7a then confirms the coupling request and the first and second devices 1, 2 of a personal protective equipment are coupled to each other. This means that a further, application-specific data exchange can then take place between the two devices 1, 2.

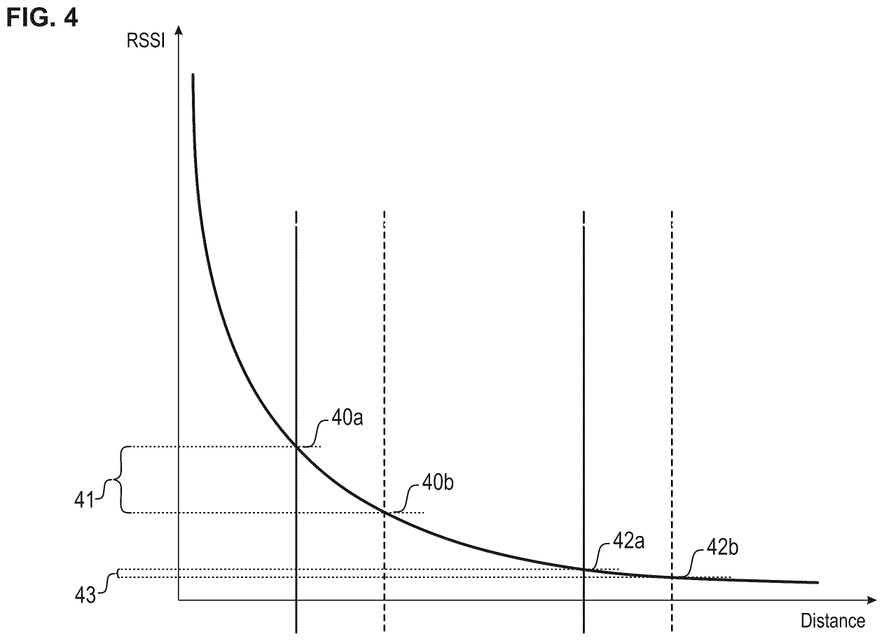

FIG. 4 schematically shows the relationship between the signal strength, in this case RSSI, and the distance from a transmitter to a receiver. The curve essentially runs like a hyperbola. The RSSI, i.e. the signal strength, is very high at a short distance between a transmitter and a receiver and decreases non-linearly with greater distance, first strongly and then less strongly as the distance increases. This curve describes how the signal strength behaves as a function of the distance between the transmitter and receiver in free space, i.e. without obstacles between the transmitter and receiver and without reflections. The invention makes advantageous use of this property of wireless signal transmission in order to recognize and couple devices belonging together in personal protective equipment. FIG. 4 shows the first and second measured signal strengths 40a, 40b of the first registration signal S1 of the first device 1 and the third and fourth measured signal strengths 42a, 42b of the second registration signal S2 of the third device 3. In this embodiment example, the first and second devices 1, 2 again belong together and have a smaller distance between them than the second and third devices 2, 3. As can be seen from FIG. 4, this results in the first and second signal strengths 40a, 40b of the first registration signal S1 transmitted by the first device 1 being greater than the third and fourth signal strengths 42a, 42b of the second registration signal S2 transmitted by the third device 3. Furthermore, the essentially hyperbolic shape of the curve results in a larger first difference value 41 of the first and second signal strengths 40a, 40b than the second difference value 43 of the third and fourth signal strengths 42a, 42b.

In practice, in which there is usually no free space and the second and fourth signal strengths 40b, 42b are additionally attenuated by the radio signal attenuating element 11, which may be a body part, the first difference value 41 increases more than the second difference value 43 and there is an even greater difference between the difference values 41, 43. The arrangement of the first and second receivers 4a, 4b according to the invention thus makes it possible to detect associated devices of personal protective equipment very reliably.

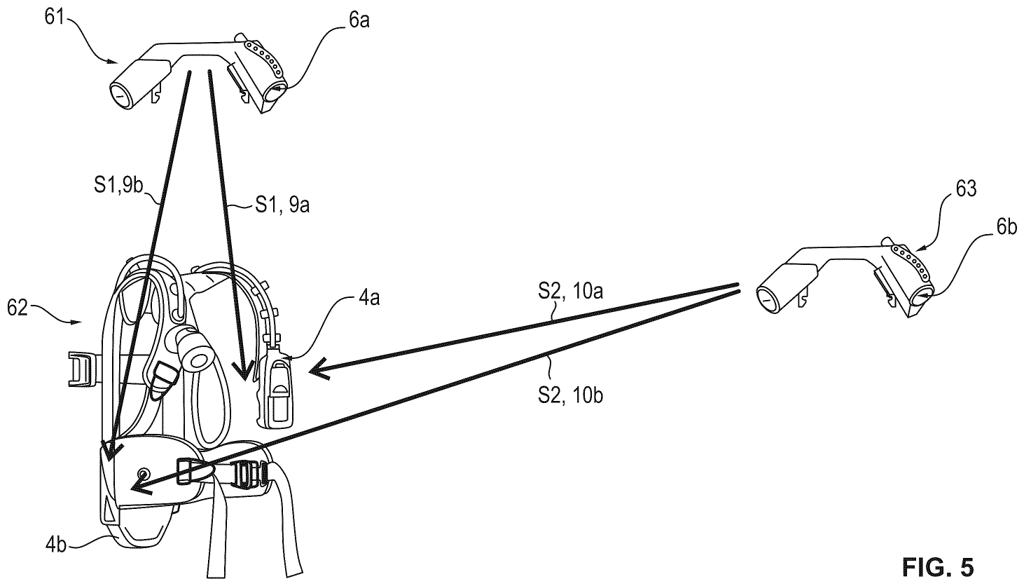

FIG. 5 schematically shows a compressed air breathing apparatus 62 with a second device 2 without a breathing gas cylinder and first and second display units 61, 63, also called head-up displays (HUDs), with a first device 1 and a third device 3. The HUDs 61, 63 comprise first and second transmitters 6a, 6b, which are configured to communicate wirelessly via Bluetooth with the receivers 4a, 4b of the compressed air breathing apparatus 62. The HUDs 61, 63 can be integrated into a respirator mask, not shown, so that they are located in the field of vision of a wearer of the respirator mask. The arrangement of the HUDs 61, 63 in relation to the compressed air breathing apparatus 62 in FIG. 5 is intended to indicate that the first HUD 61 and the compressed air breathing apparatus 62 belong together and are part of the personal protective equipment of a person not shown, who wears the first HUD 61 and the compressed air breathing apparatus 62 on the body. The second HUD 63 is part of the personal protective equipment of another person, not shown, and is located at least within reach of the receivers 4a, 4b of the compressed air breathing apparatus 62. The first receiver 4a is arranged on the compressed air breathing apparatus 62 in such a way that the first receiver 4a is located in front of the torso of the wearer of the compressed air breathing apparatus 62 on the upper body and thus close to the intended position of the first HUD 61. The second receiver 4b is located behind the torso of the wearer in the lower back area and thus further away from the intended position of the first HUD 61. Due to this particular arrangement, registration signals on the first, second, third and fourth paths 9a, 9b, 10a, 10b between the HUDs 61, 63 and the receivers 4a, 4b experience different attenuation. The different attenuation results from the different distances between the HUDs 61, 63 and the receivers 4a, 4b as well as due to the partial course of the registration signals S1, S2 through the body of the wearer of the compressed air breathing apparatus 62. The first transmitter 6a of the first HUD 61 transmits a first registration signal S1, which is received by the first receiver 4a via the first path 9a and by the second receiver 4b via the second path 9b. The measuring units 5a and 5b of the receivers 4a, 4b, which are not shown in FIG. 5, measure a first and a second signal strength of the first registration signal S1 and transmit these to the evaluation unit 5 of the compressed air breathing apparatus 62, located as indicated in FIG. 5, which determines a first difference value from this. Accordingly, the second HUD 63 transmits a second registration signal S2, which is received by the first receiver 4a via the third path 10a and by the second receiver 4b via the fourth path 10b. As described above, a third and a fourth signal strength of the second registration signal S2 are measured and transmitted to the evaluation unit 5, which determines a second difference value therefrom. The evaluation unit 5 then compares the first difference value with the second difference value, the second difference value in this embodiment example being smaller than the first difference value, since the distance of the second HUD 63 to the compressed air breathing apparatus 62 and the receivers 4a, 4b is greater than the distance of the first HUD 61 to the compressed air breathing apparatus 62 and its receivers 4a, 4b. Accordingly, an automatic coupling of the compressed air breathing apparatus 62 with the first HUD 61 takes place.

The invention has been described above with reference to preferred embodiments and illustrated in the figures. These descriptions and illustrations are purely schematic and do not limit the scope of protection of the claims, but serve only to illustrate them by way of example. It is understood that the invention can be implemented and modified in a variety of ways and that individual features of the embodiments can be freely combined with one another, where technically expedient, without departing from the scope of protection of the patent claims. While specific embodiments of the invention have been shown and described in detail to illustrate the application of the principles of the invention, it will be understood that the invention may be embodied otherwise without departing from such principles.

List of reference symbols

| | |
|---|---|
| 1 | First device |
| 2 | Second device |
| 3 | Third device |
| 4a | First receiver (first receiver of the second device) |
| 4b | Second receiver (second receiver of the second device) |
| 5a | First measuring unit (first measuring unit of the second device) |
| 5b | Second measuring unit (second measuring unit of the second |
| | device) |
| 6a | First transmitter (first device transmitter) |
| 6b | Second transmitter (third device transmitter) |
| S1 | First registration signal (first device registration signal) |
| S2 | Second registration signal (third device registration signal) |
| 7a | First coupling unit |
| 7b | Second coupling unit |
| 7c | Third coupling unit |
| 8 | Evaluation unit |
| 9a | First section of the first registration signal |
| 9b | Second leg of the first registration signal |
| 10a | First section of the second registration signal |
| 10b | Second leg of the second registration signal |
| 11 | Radio signal attenuating element |
| 20 | First process step |
| 21 | Second process step |
| 22 | Third process step |
| 23 | Fourth process step |
| 24 | Fifth process step |
| 40a | First measured signal strength of the first registration signal |
| 40b | Second measured signal strength of the first registration signal |
| 41 | First difference value |
| 42a | First measured signal strength of the second registration signal |
| 42b | Second measured signal strength of the second registration signal |
| 43 | Second difference value (third device signal strength difference |
| | value) |
| 61 | First display unit for a respirator mask |
| 62 | Compressed air breathing apparatus |
| 63 | Second display unit for a respirator mask |

What is claimed is:

1. A process of coupling a first device and a second device of personal protective equipment, which are configured to communicate wirelessly with each other, the process comprising the steps of:
transmitting a first device registration signal from a first device transmitter of the first device;
receiving the first device registration signal with a first receiver of the second device and receiving the first device registration signal with a second receiver of the second device, the first device registration signal experiencing a different attenuation on a first path from the first device transmitter to the first receiver than on a second path from the first device transmitter to the second receiver;
measuring a first path signal strength of the first device registration signal transmitted via the first path and measuring a second path signal strength of the first device registration signal transmitted via the second path;
determining a first device signal strength difference value of the first path signal strength and the second path signal strength; and
coupling the first device and the second device, or not coupling of the first device and the second device, based on the first device signal strength difference value.

2. The process according to claim 1, further comprising the steps of:
receiving a third device registration signal of a third device transmitter of a third device, transmitted via a third path, with the first receiver of the second device and receiving the third device registration signal, transmitted via a fourth path, with the second receiver of the second device, the third device registration signal experiencing a different attenuation on the third path from the third device transmitter to the first receiver than on the fourth path from the third device transmitter to the second receiver;
measuring a third path signal strength of the third device registration signal transmitted via the third path and measuring a fourth path signal strength of the third device registration signal transmitted via the fourth path;
determining a third device signal strength difference value of the third path signal strength and the fourth path signal strength; and
coupling of the first device and the second device or coupling the third device and the second device based on the first device signal strength difference value and the third device signal strength difference value.

3. A process according to claim 1, wherein the process steps are repeated.

4. A process according to claim 2, wherein the process steps are repeated.

5. A process according to claim 1, wherein a sign of the first device signal strength difference value is taken into account in the coupling.

6. A process according to claim 2, wherein a sign of the first device signal strength difference value is taken into account in the coupling and/or a sign of the third device signal strength difference value is taken into account in the coupling.

7. A process according to claim 1, wherein the transmission of the first device registration signal and the determination of the first device signal strength difference value is repeated a plurality of times before the coupling.

8. A process according to claim 7, wherein a first characteristic value based on at least two first device difference values is taken into account in the coupling.

9. A process according to claim 2, wherein the transmission of the first device registration signal and/or the transmission of the third device registration signal and the determination of the first device signal strength difference value and/or the determination of the third device signal strength difference value is repeated a plurality of times before the coupling.

10. A process according to claim 9 wherein a first characteristic value, based on at least two first device signal strength difference values, and/or a second characteristic value based on at least two third device signal strength difference values is taken into account in the coupling.

11. A process according to claim 1, wherein the first device is configured to be attached at least indirectly to a head of a person and the second device is configured to be attached at least indirectly to a torso of a person.

12. A process according to claim 11, wherein the second device is configured such that the torso of a person is located between the first receiver and the second receiver with the second device attached at least indirectly to the person.

13. A process according to claim 2, wherein the first device and the third device are configured to be attached at least indirectly to a head of a person and the second device is configured to be attached at least indirectly to the torso of a person.

14. A process according to claim 7 wherein the second device is configured such that the torso of a person is located between the first receiver and the second receiver, with the second device attached at least indirectly to the person.

15. A process according to claim 1, wherein the first device transmitter is arranged on a first display unit for a respiratory mask and the first receiver, and the second receiver are arranged on a compressed air breathing apparatus.

16. A process according to claim 2, wherein the first device transmitter is arranged on a first display unit for a respiratory mask and/or the third device transmitter is arranged on a second display unit for a respiratory mask, and the first receiver and the second receiver are arranged on a compressed air breathing apparatus.

17. A process according to claim 1, wherein a signal strength is measured based on a received signal strength indication (RSSI) value of the first device registration signal.

18. A process according to claim 2, wherein a signal strength is measured based on a received signal strength indication (RSSI) value of the first device registration signal and or of the third device registration signal.

19. A process according to claim 1, wherein the wireless communication is based on a Bluetooth radio technology.

20. A system for personal protective equipment, the system comprising a device to be wirelessly coupled with another device, the device comprising:
a first receiver and a second receiver for receiving a registration signal, the first receiver having a first measuring unit for measuring a first measuring unit signal strength of the registration signal received at the first receiver and the second receiver having a second measuring unit for measuring a second measuring unit signal strength of the registration signal received at the second receiver;
an evaluation unit for determining a signal strength difference value of the first measuring unit signal strength and the second measuring unit signal strength and for evaluating the determined difference value; and
a device coupling unit for wireless coupling with a coupling unit of another device.

21. A system according to claim 20, wherein the device is a second device and the device coupling unit is a second device coupling unit and further comprising a first device, wherein the first device comprises:
a first device transmitter for transmitting the registration signal; and
a first device coupling unit for wireless coupling with the second device coupling unit.

22. Personal protective equipment comprising:
a compressed air breathing apparatus; and
a device connected to the compressed air breathing apparatus, the device comprising:
a first receiver and a second receiver for receiving a registration signal, the first receiver having a first measuring unit for measuring a first measuring unit signal strength of the registration signal received at the first receiver and the second receiver having a second measuring unit for measuring a second measuring unit signal strength of the registration signal received at the second receiver;
an evaluation unit for determining a signal strength difference value of the first measuring unit signal strength and the second measuring unit signal strength and for evaluating the determined difference value; and
a device coupling unit for wireless coupling with a coupling unit of another device.

23. Personal protective equipment according to claim 22, further comprising:
a display unit for a respirator mask, wherein the device is a second device and the device coupling unit is a second device coupling unit; and
a first device connected to the display unit, wherein the first device comprises:
a first device transmitter for transmitting the registration signal; and
a first device coupling unit for wireless coupling with the second device coupling unit.
